(19) United States
(12) Patent Application Publication
(10) Pub. No.: US 2026/0103602 A1
(43) Pub. Date: Apr. 16, 2026

(54) Composite and Electronic Devices Including Liquid Metal Microparticles, and Method of Preparing Composite

(71) Applicant: SAMSUNG ELECTRONICS CO., LTD., Suwon-si (KR)

(72) Inventors: Cheonil PARK, Suwon-si (KR); Yuho WON, Suwon-si (KR); Kun Mo CHU, Suwon-si (KR); Sungjoon JOO, Suwon-si (KR)

(21) Appl. No.: 19/337,511

(22) Filed: Sep. 23, 2025

(30) Foreign Application Priority Data
Oct. 10, 2024 (KR) 10-2024-0137986

(51) Int. Cl. C09C 3/08; C08J 3/205; C08K 9/04; C09C 1/62; C09K 5/12

(52) U.S. Cl. CPC C09C 3/08; C08J 3/2053; C08K 9/04; C09C 1/62; C09K 5/12; C01P 2004/03; C01P 2004/32; C01P 2004/51; C01P 2004/61; C01P 2006/32; C08J 2329/04; C08K 2201/005

(57) ABSTRACT

Liquid metal microparticles, a method of preparing the liquid metal microparticles, a method of preparing a composite, a composite including liquid metal microparticles, and an electronic device including the liquid metal microparticles. The method of preparing liquid metal microparticles includes injecting liquid metal into a solvent using a syringe, where the syringe includes a piston and a nozzle, a diameter of the nozzle is less than or equal to about 30 micrometers, and an injection rate of the liquid metal with the syringe is greater than or equal to about 0.5 milliliters per minute, and the solvent includes a surfactant in an amount of greater than or equal to about 3 weight percent based on a total weight of the surfactant and the solvent, and the liquid metal and the solvent are each maintained at a temperature greater than or equal to a melting point of the liquid metal.

### CROSS-REFERENCE TO RELATED APPLICATION

This application is based on and claims priority Korean Patent Application No. 10-2024-0137986 filed in the Korean Intellectual Property Office on Oct. 10, 2024, and all the benefits accruing therefrom under 35 U.S.C. § 119, the content of which in its entirety is incorporated herein by reference.

### BACKGROUND

### 1. Field

Liquid metal microparticles, a method of preparing the liquid metal microparticles, a composite, and an electronic device including the liquid metal microparticles, and a method of preparing the composite are disclosed.

### 2. Description of the Related Art

Liquid metal, that is, metal or an alloy thereof that exists in a liquid state at a relatively low temperature range (for example, greater than or equal to about 10° C. to less than about 100° C.) by having a melting point at room temperature, for example, within a relatively low temperature range of greater than or equal to about 10° C. to less than about 100° C., exhibits different properties from those of general metal or an alloy thereof that exists in a solid state within the above temperature range. Liquid metals thus may be advantageously applied in various fields. Accordingly, efforts are being made to prepare the liquid metal into uniform microparticles in a suitable form for application to a desired field, for example, a uniform size and/or shape to exhibit uniform properties.

However, there is still a problem that the microparticles are aggregated due to high surface energy of the liquid metal and/or much higher surface energy of the microparticles prepared therefrom due to the very small size, which may make it still difficult to prepare the liquid metal microparticles with a uniform size and/or shape and a suitable size and/or shape for the intended application.

### SUMMARY

An embodiment provides a method of preparing liquid metal microparticles having a uniform particle size and shape within a specific range, which is advantageously applicable in various fields by exhibiting low cost and high productivity.

Another embodiment provides spherical liquid metal microparticles having a specific range of average particle sizes and a narrow particle size distribution to exhibit a uniform particle size, prepared by a method according to an embodiment.

Another embodiment provides a composite including the liquid metal microparticles according to an embodiment and a polymer matrix in which the liquid metal microparticles are dispersed.

Another embodiment provides a method of preparing a composite according to an embodiment.

Another embodiment provides an electronic device including the liquid metal microparticles according to an embodiment, and/or a composite according to an embodiment including the same.

The method of preparing liquid metal microparticles according to an embodiment includes injecting a liquid metal into a solvent using a syringe, wherein the syringe includes a piston and a nozzle, a diameter of the nozzle is less than or equal to about 30 micrometers (μm), and an injection rate of the liquid metal with the syringe is greater than or equal to about 0.5 milliliters per minute (mL/min), the solvent includes a surfactant in an amount of greater than or equal to about 3 weight percent (wt %) based on a total weight of the surfactant and the solvent, and the liquid metal and the solvent are each maintained at a temperature greater than or equal to a melting point of the liquid metal.

The liquid metal includes gallium, indium, tin, bismuth, copper, mercury, lead, gold, silver, or an alloy thereof.

The solvent includes ethanol, water, isopropyl alcohol, acetone, or a mixture thereof.

The surfactant includes a cationic surfactant, an anionic surfactant, a nonionic surfactant, or a combination thereof.

The surfactant includes an anionic surfactant, and the anionic surfactant includes sodium dodecyl sulfate (SDS).

The temperature greater than or equal to the melting point of the liquid metal is greater than or equal to about 40° C. and less than or equal to about 60° C.

The liquid metal includes gallium and indium, and the temperature greater than or equal to the melting point of the liquid metal is about 45° C. to about 55° C.

An average particle diameter of the liquid metal microparticles is less than or equal to about 30 μm, and the liquid metal microparticles have a particle size distribution within +30% of the average particle diameter.

The diameter of the syringe nozzle is greater than or equal to about 1 μm and less than or equal to about 20 μm.

The diameter of the above syringe nozzle is greater than or equal to about 5 μm and less than or equal to about 10 μm.

An average particle diameter of the liquid metal microparticles is greater than or equal to about 10 μm and less than or equal to about 30 μm, and the liquid metal microparticles have a particle size distribution within +30% of the average particle diameter.

The method of preparing liquid metal microparticles produces liquid metal microparticles at a rate of greater than or equal to about 150 grams (g) per hour.

The liquid metal microparticles according to another embodiment have an average particle diameter of less than or equal to about 30 μm and a particle size distribution within +30% of the average particle diameter.

The liquid metal microparticles include gallium, indium, tin, bismuth, copper, mercury, lead, gold, silver, or an alloy thereof.

The liquid metal microparticles include a surfactant on their surface.

The method of preparing a composite according to another embodiment includes producing the liquid metal microparticles prepared by the method of preparing liquid metal microparticles according to an embodiment to provide a prepared liquid metal microparticles, and mixing the prepared liquid metal microparticles with a polymer.

The composite is included in an inkjet composition, electronic circuits, thermal interface materials (TIM), a heat dissipation sheet, an energy storage device, a chemical sensor, a conductive metal bonding material, or a medical biomaterial.

The composite according to another embodiment includes liquid metal microparticles dispersed within a polymer matrix, wherein the liquid metal microparticles have an average particle diameter of less than or equal to about 30 μm and a particle size distribution within +30% of the average particle diameter, and are spherical.

The liquid metal microparticles in the composite include gallium, indium, tin, bismuth, copper, mercury, lead, gold, silver, or an alloy thereof.

The electronic device according to another embodiment includes the liquid metal microparticles according to an embodiment, or a composite according to another embodiment.

The method of preparing liquid metal microparticles according to an embodiment of the present invention enables mass production of liquid metal microparticles having uniform size and shape at low cost and quickly using a general medical syringe, thereby suggesting possibility of mass production of liquid metal microparticles that enable stable supply and use of liquid metal microparticles exhibiting uniform physical properties and excellent effects in various fields where liquid metal may be applied. In addition, the liquid metal microparticles prepared by using the method may be prepared as spherical particles having an average particle diameter within a specific range and a low particle size distribution within +30% of the average particle diameter, and thus it can be expected that they will be able to exhibit uniform and excellent liquid metal effects in various technical fields.

### BRIEF DESCRIPTION OF THE DRAWINGS

FIG. 1 is a schematic view illustrating a method of preparing liquid metal microparticles according to an embodiment.

FIG. 2 is a scanning electron microscope (SEM) image of liquid metal microparticles prepared according to Example 1.

FIG. 3 is a scanning electron microscope (SEM) image of liquid metal microparticles prepared according to Example 2.

FIG. 4 is a scanning electron microscope (SEM) image showing the amorphous structure of liquid metal prepared according to Comparative Example 1.

FIG. 5 is a scanning electron microscope (SEM) image showing the amorphous structure of liquid metal prepared according to Comparative Example 2.

FIG. 6 is a scanning electron microscope (SEM) image showing the amorphous structure of liquid metal prepared according to Comparative Example 3.

FIG. 7 is a scanning electron microscope (SEM) image of liquid metal microparticles prepared according to Comparative Example 4.

FIG. 8 is a scanning electron microscope (SEM) image of liquid metal microparticles prepared according to Comparative Example 5.

FIG. 9 is a scanning electron microscope (SEM) image of liquid metal microparticles prepared according to Comparative Example 6.

### DETAILED DESCRIPTION

Hereinafter, example embodiments of the present disclosure will be described in detail so that a person skilled in the art would understand the same. This disclosure may, however, be embodied in many different forms and is not construed as limited to the example embodiments set forth herein.

The terminology used herein is used to describe embodiments only, and is not intended to limit the present disclosure. The singular expression includes the plural expression unless the context clearly dictates otherwise.

The term “combination thereof” herein means a mixture, a stack, a composite, a copolymer, an alloy, a blend, a reaction product, and the like of constituents.

Here, “metal” may include a semi-metal in addition to a general metal.

Here, “liquid metal” includes a metal, or an alloy of metals, for example, an alloy composition, which exhibits a liquid state at room temperature, i.e., at a relatively low temperature, for example, in the range of from about 10° C. to about 100° C., or of from about 10° C. to about 80° C.

Here, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within +10% or +5% of the stated value.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

The term “layer” includes a construction having a shape formed on a part of a region, in addition to a construction having a shape formed on an entire region.

As used herein, “size” means an average particle diameter in the case of a sphere and the length of the longest portion in the case of a non-spherical shape. The size may be measured by a method well known to those skilled in the art, for example, may be measured by a particle size analyzer, or may be measured by analysis of a transmission electron micrograph or a scanning electron micrograph. Alternatively, it is possible to obtain an average particle diameter value by measuring utilizing a dynamic light scattering method, performing data analysis, counting the number of particles for each particle size range, and calculating from these data. Unless otherwise defined, the average particle diameter may mean the diameter (D₅₀) of particles having a cumulative volume of 50 volume % in the particle size distribution.

Here, the term “or” is not to be construed as an exclusive meaning, and for example, “A or B” is construed to include A, B, A+B, and/or the like.

Liquid metal, which maintains a liquid state at room temperature or an operation temperature near to the room temperature of a device to which the liquid metal may be applied, may be flexibly deformed according to changes in a shape of the device and thus exhibit characteristics such as intrinsic electrical conductivity and/or thermal conductivity of the metal without causing damage such as scratches and the like on the device and without being destroyed by the deformation itself. Furthermore, as an electronic device and the like have become smaller and thinner in size, a thermal interface material for dissipating heat generated from a semiconductor elements or parts to a heat sink or a metal adhesive for adhering semiconductor elements or parts needed to manufacture the device also should be reduced in size or made thinner. The metal adhesive should be able to bond metals, while maintaining the electrical conductivity, and thus should contain an electrically conductive filler. In addition, the thermal interface material requires a reinforcing filler to provide durability. It is also advantageous if the electrically conductive filler and/or the reinforcing filler provide thermal conductivity to transfer heat generated from the electronic parts to the heat sink. A thermally conductive filler may also be used. Conventionally, fillers included in such a metal adhesive or thermal interface material, include metal or ceramic, graphite, carbon fiber sheet, and the like, but with reduction in size and thickness of electronic parts and development of flexible and/or stretchable devices and the like, attempts are being made to use microparticles of liquid metal having excellent thermal and/or electrical conductivity and/or flexibly response to shape deformation as a filler of the adhesive and/or thermal interface material. Here, the desirable liquid metal microparticles are reducible in size according to a size or thickness of the adhesive and/or thermal interface material, and in addition, have a uniform particle size and/or shape.

Accordingly, previous studies have been reported to prepare liquid metal into spherical microparticles of less than or equal to about 1 millimeter (mm). For example, Korean Patent No. 10-1993812 discloses a method of producing liquid metal microparticles with a diameter of less than or equal to about 10 μm by applying ultrasonic waves to the tank (i.e., bath sonication). Pieere H. A. Vaillant et al. discloses a method of producing liquid metal microparticles with a diameter of less than or equal to about 1 μm by dipping a probe in a solvent including the liquid metal to apply high ultrasonic energy thereto (probe sonication) (Beneath the Skin: Nanostructure in the Sub-Oxide Region of Liquid Metal Nanodroplets, Advanced Functional Materials, 2023, 2310147). Simge Cinar et al. discloses a method of producing liquid metal microparticles with a diameter of less than or equal to about 10 μm by breaking liquid metal into small particles using shear blending (see, Mechanical Fracturing of Core-Shell Undercooled Metal Particles for Heat-Free Soldering; Scientific Reports, 23 Feb. 2016). These bath sonification, probe sonification, and shear blending methods may prepare liquid metal microparticles with a size of less than or equal to about 1 mm, but have drawbacks, in that the prepared microparticles have a very wide particle size distribution from several nanometers (nm) to hundreds of micrometers (μm) due to non-uniform energy application. In addition, nanoparticles (those with a sub-micron size of less than or equal to about 1 μm), which have a weak inter-particle repulsion force caused by high surface free energy, are not evenly dispersed in the solvent but aggregated. The aggregated nanoparticles also disadvantageously stick to the surface of relatively large micrometer-sized particles, which may reduce a surface reaction or lower a sphericity of the microparticles. Furthermore, these ultrasonic or physical grinding methods have a tendency such that the longer the process time, the more even distribution of the grinding energy, and thereby, the smaller diameter of the final microparticles. Accordingly, in order to control the nonuniform distribution of the microparticles, it takes more than a predetermined amount of time for processing. If the ultrasonic or physical grinding methods are applied, in order to prepare microparticles with a uniform diameter, in general, greater than or equal to about 1 hour of the process time is needed, which may lead to increasing a production cost and worse overall preparation efficiency such as a decrease in an amount prepared per unit time.

As a method of preparing liquid metal microparticles with controlled particle size, a method of preparing uniform liquid metal microparticles with a diameter of about 50 μm to about 100 μm may be carried out by preparing a special microfluidic chip and controlling a diameter of a nozzle of the microfluidic chip (Tanya Hutter et al., Formation of Spherical and Non-Spherical Eutectic Gallium-Indium Liquid-Metal Microdroplets in Microfluidic Channels at Room Temperature, Advanced Functional Materials, 2012, 22, 2624-2631). Another method of controlling liquid metal microparticles to have a uniform size may be by applying a repeated natural precipitation method to the liquid metal microparticles prepared by the previous bath sonication method (Aastha Uppal et al., Pressure-Activated Thermal Transport via Oxide Shell Rupture in Liquid Metal Capsule Beds, ACS Applied Materials and Interfaces, 2020, 12, 2625-2633). However, the method of preparing liquid metal microparticles by using the microfluid chip, which is advantageous for precisely controlling a diameter of the liquid metal microparticles, needs to separately prepare the special microfluid chip and prepares a relatively smaller amount of the liquid metal microparticles per unit time than the conventional ultrasonic or physical grinding method, and is not suitable for mass production of the liquid metal microparticles. In addition, the method of controlling the size distribution of microparticles by using the repeated natural precipitation method after the previous ultrasonic bath process, drastically lowers the overall prepared yield due to a significant amount loss of liquid metal, and also increases the overall preparing time due to the introduction of additional processes after preparing the liquid metal microparticles, and thus is also not suitable for mass production of the liquid metal microparticles.

A method of preparing liquid metal microparticles using a needle and a syringe at room temperature has been described (Yang Yu et al., Channelless Fabrication for Large-Scale Preparation of Room Temperature Liquid Metal Droplets, Advanced Engineering Materials, 2014, 16, No. 2). Another method of controlling a size of the liquid metal microparticles according to a diameter of a glass tube through which the liquid metal is ejected by spraying the liquid metal with high-pressure nitrogen gas (Fali Li et al., Ultra-conformable liquid metal particle monolayer on air/water interface for substrate-free E-tattoo, npj Flexible Electronics 2023 31) has been reported. However, these two methods disclose no liquid metal microparticles having a diameter of less than or equal to about 50 μm or a diameter of less than or equal to about 30 μm, and the method of preparing the liquid metal microparticles by injecting high-pressure nitrogen gas, which requires a glass tube and special high-pressure gas for preparing the microparticles, also has a problem of increasing a process cost.

The method for preparing liquid metal microparticles according to an embodiment as described herein does not include the problems of the above conventional methods, but may rapidly and easily provide spherical liquid metal microparticles with high uniformity in a large amount at a low production cost by controlling a nozzle diameter of a commonly available syringe, an injection rate of liquid metal, a temperature of the liquid metal and a dispersion solvent, and a concentration of a surfactant in the dispersion solvent. In addition, the prepared liquid metal microparticles may not only have a uniform size and shape but also may be easily prepared to have an average particle diameter of less than or equal to about 30 μm by adjusting the nozzle diameter of the syringe and thus advantageously applied to various materials and parts to which the liquid metal particles may be applied.

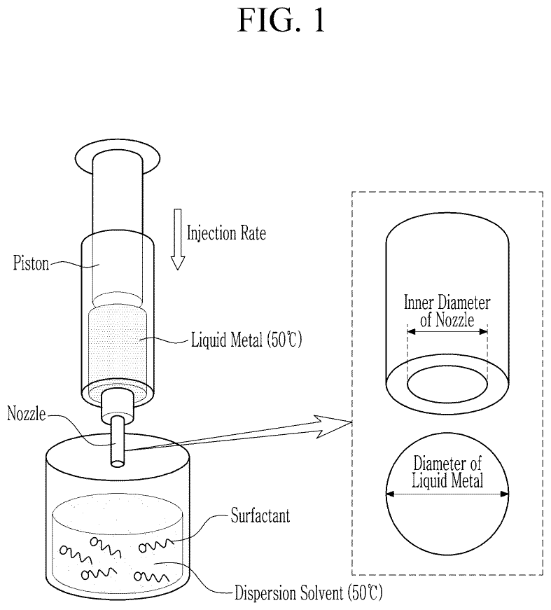

FIG. 1 is a schematic view illustrating a method of preparing liquid metal microparticles using a syringe according to an embodiment.

As shown in FIG. 1, the method of preparing liquid metal microparticles according to an embodiment includes adding liquid metal for preparing microparticles to a common syringe with a piston and a nozzle or a needle, injecting the liquid metal into a dispersion solvent including a surfactant at a predetermined concentration or more at a predetermined rate by pushing the piston of the syringe to disperse the liquid metal injected through the needle (or the nozzle) of the syringe into the dispersion solvent as spherical particles due to high surface energy.

Metals capable of preparing microparticles of liquid metal by the method according to an embodiment may include, for example, gallium, indium, tin, bismuth, copper, mercury, lead, gold, silver, or an alloy thereof, and may also include any composition of the metals capable of maintaining a liquid state at a relatively low temperature, for example, greater than or equal to about 10° C. and less than about 100° C. For example, the metal may include gallium and indium, and may include an alloy of gallium and indium, such as a eutectic gallium indium alloy (EGaln), but is not limited thereto.

In a method according to an embodiment, the dispersion solvent may include ethanol, water, isopropyl alcohol, acetone, or a mixture thereof, but is not limited thereto. In an embodiment, the dispersion solvent may include distilled water.

In a method according to an embodiment, a concentration of the surfactant included in the dispersion solvent may be greater than or equal to about 3 wt % based on a total weight of the dispersion solvent. When liquid metals are made of micrometer-(micron⁻) sized particles, their high surface energy allows them to re-aggregate within the dispersion medium. By including greater than or equal to about 3 wt % of a surfactant in the dispersion solvent, the surfactant binds to the surface of the liquid metal microparticles, thereby preventing re-aggregation of the microparticles, and thus liquid metal microparticles maintaining a uniform particle size and spherical shape can be obtained. As can be seen from the examples and comparative examples described herein, when an amount of the surfactant is less than 3 wt %, the surfactant does not sufficiently cover the surface of the liquid metal microparticles, so that re-aggregation of the microparticles occurs, and accordingly, the average particle diameter of the microparticles in the dispersion solvent increases or the shape of the microparticles becomes non-uniform, and further, the size distribution of the microparticles becomes wide, so that it may be difficult to prepare microparticles having a desired average particle diameter and uniform size and shape. A maximum amount of the surfactant is not particularly limited. For example, the surfactant may be included in an amount of up to about 10 wt %, about 15 wt %, or about 20 wt %, based on a total weight of the dispersion solvent.

Any surfactant commonly used may be used without limitation. For example, an anionic surfactant, a cationic surfactant, an amphoteric surfactant, a non-ionic surfactant, or a mixture of two or more thereof may be included. For example, the anionic surfactant may include a soap, i.e., a sodium fatty acid (RCOO⁻ Na⁺), a monoalkyl sulfate (ROSO₃⁻ M⁺), an alkoxyl polyoxyethylene sulfate (RO(CH₂CH₂O)ₘesₒₙ⁻ M⁺), an alkylbenzene sulfonate (RR′CH₂CHC₆H₄SO₃⁻ M⁺), a monoalkyl phosphate (ROPO(OH)O⁻ M⁺), sodium dodecyl sulfate (SDS), and the like, the cationic surfactant may include a trimethylammonium salt (N⁺(CH₃)₃ X⁻), a dialkyldimethylammonium salt (RR′N⁺(CH₃)₂X⁻), an alkylbenzylmethylammonium salt (RN⁺(CH₂Ph) (CH₃)₂X⁻), and the like, and the amphoteric surfactant may include an alkylsulfobetaine (RR′R″N⁺(CH₂)ₙSO₃⁻), an alkylcarboxybetaine (R(CH₃)₂N⁺CH₂COO⁻), and the like, and the non-ionic surfactant may include a polyoxyethylene alkyl ether (RO(CH₂CH₂O)ₘH), a fatty acid sorbitan ester, a fatty acid diethanolamine (RCON(CH₂CH₂OH)₂), an alkyl monoglyceryl ether (ROCH₂CH(OH)CH₂OH), and the like. Surfactants sold under trade names such as Triton X, Pluronic, and Tween are also included. In the above chemical formulas, R, R′, and R″ represents an organic hydrocarbyl group and M represents a metal atom. For example, R, R′, and R″ may each independently be a C₁₋₃₆ alkyl, C₁₋₃₆ alkenyl, or C₁₋₃₆ alkynyl, provided that at least one of the groups has a sufficient number of carbon atoms to provide a surfactant effect if not provided by another group in the surfactant.

In an embodiment, the surfactant may be an anionic surfactant, such as sodium dodecyl sulfate (SDS), but not limited thereto.

An injection rate at which the piston of the syringe injects the liquid metal into the dispersion solvent may be greater than or equal to about 0.5 milliliters (mL) per minute, i.e., 0.5 milliliters per minute (mL/min), and by maintaining constant injection rate, microparticles of liquid metal having a uniform size and shape may be prepared. As can be seen from the examples and comparative examples described herein, when the injection rate is less than about 0.5 mL/min, for example, when the injection rate is 0.1 mL/min, the speed of injection from the syringe is too slow, so that the liquid metal may not be injected into the dispersion solvent from the nozzle (needle) tip of the syringe and may remain there for a longer time. This may result in a larger amount of liquid metal collected at the tip of the syringe needle prior to injection, and thus the size of the injected liquid metal particles may be much larger than the desired average particle size. That is, in order to maintain the liquid metal microparticles in a uniform size and shape below a specific particle size, for example, less than or equal to about 30 μm, the injection rate may be greater than or equal to about 0.5 mL/min, for example, 0.6 mL/min, 0.7 mL/min, 0.8 mL/min, 0.9 mL/min, or 1.0 mL/min, but is not limited thereto.

Liquid metal microparticles having an average particle diameter within a desired range may be prepared by controlling the inner diameter of the needle (or nozzle) of the syringe. For example, the inner diameter of the needle (or nozzle) of the syringe may be less than or equal to about 30 μm, for example, greater than or equal to about 1 μm and less than or equal to about 30 μm, for example, greater than or equal to about 1 μm and less than or equal to about 30 μm, greater than or equal to about 1 μm and less than or equal to about 25 μm, greater than or equal to about 1 μm and less than or equal to about 20 μm, greater than or equal to about 1 μm and less than or equal to about 15 μm, greater than or equal to about 1 μm and less than or equal to about 10 μm, greater than or equal to about 2 μm and less than or equal to about 30 μm, greater than or equal to about 2 μm and less than or equal to about 25 μm, greater than or equal to about 2 μm and less than or equal to about 20 μm, greater than or equal to about 2 μm and less than or equal to about 15 μm, greater than or equal to about 2 μm and less than or equal to about 10 μm, greater than or equal to about 3 μm and less than or equal to about 30 μm, greater than or equal to about 3 μm and less than or equal to about 25 μm, greater than or equal to about 3 μm and less than or equal to about 20 μm, greater than or equal to about 3 μm and less than or equal to about 15 μm, greater than or equal to about 3 μm and less than or equal to about 10 μm, greater than or equal to about 5 μm and less than or equal to about 30 μm, greater than or equal to about 5 μm and less than or equal to about 25 μm, greater than or equal to about 5 μm and less than or equal to about 20 μm, greater than or equal to about 5 μm and less than or equal to about 15 μm, or greater than or equal to about 5 μm and less than or equal to about 10 μm, but is not limited to these ranges.

As shown in FIG. 1, the liquid metal is pushed out of the syringe through the syringe needle (or nozzle), and at this time, due to the high surface energy of the liquid metal, the liquid metal becomes a spherical particle and has a particle diameter larger than the inner diameter of the syringe needle. Thus, for example, by selecting the inner diameter of a syringe needle within a specific range, it is possible to obtain microparticles of liquid metal having a particle diameter larger than the inner diameter. According to an embodiment, the average particle diameter of the liquid metal microparticles may be less than or equal to about 30 μm, and therefore, the maximum inner diameter of the syringe needle may also be 30 μm.

A method of preparing liquid metal microparticles according to an embodiment may be performed at a temperature higher than the melting point of the liquid metal so that the liquid metal may maintain a liquid state. The melting point of a liquid metal may vary depending on the type of liquid metal and/or, in the case of an alloy, the type and composition of the metals that make up the alloy. In general, liquid metal means a metal that is liquid at room temperature, for example, at a relatively low temperature range of greater than or equal to 10° C. and less than or equal to about 100° C., for example, greater than or equal to 10° C. and less than or equal to about 80° C., for example, greater than or equal to 10° C. and less than or equal to about 60° C. Therefore, depending on the type of liquid metal used in performing the preparation method according to an embodiment, the preparation method may be performed at a temperature above the melting point of the metal. To this end, the temperature of the liquid metal within the syringe and the solvent in which the liquid metal is dispersed may both be a temperature above the melting point of the liquid metal. In an embodiment, the temperature above the melting point may be, for example, greater than or equal to about 40° C. and less than or equal to about 60° C., for example, greater than or equal to about 45° C. and less than or equal to about 60° C., for example, greater than or equal to about 50° C. and less than or equal to about 60° C., for example, greater than or equal to about 55° C. and less than or equal to about 60° C., for example, greater than or equal to about 45° C. and less than or equal to about 55° C., or for example, about 50° C., but is not limited to these ranges. As can be seen from the examples and comparative examples described herein, when a method similar to the method of preparing liquid metal microparticles according to an embodiment is performed at a temperature below the melting point of the liquid metal, microparticles having a uniform size and shape are not prepared, but particles having an irregular amorphous structure are generated. That is, since the metal cannot maintain a liquid state, some of it solidifies into a solid state and exhibits an amorphous structure.

A method of preparing liquid metal microparticles according to an embodiment can very rapidly mass-produce liquid metal microparticles having an average particle diameter of less than or equal to about 30 μm and a particle size distribution within +30% of the average particle diameter, i.e., a uniform size, and a substantially spherical shape. As can be seen from the examples and comparative examples described herein, the method of preparing liquid metal microparticles according to an embodiment may provide liquid metal microparticles having a uniform size and shape with a productivity incomparably higher than that of the existing methods of preparing liquid metal microparticles by ultrasonic treatment (grinding), physical grinding, particle size separation by natural sedimentation, and using microfluid chips, and may provide liquid metal microparticles having the uniform average particle diameter and narrow particle size distribution of, for example, greater than about 150 grams per hour, for example, about 180 grams per hour. This also shows higher productivity compared to the existing method of preparing liquid metal microparticles using a syringe (about 150 grams per hour), similar to the embodiment of the present application.

According to a method of preparing liquid metal microparticles according to an embodiment, liquid metal microparticles having an average particle diameter of less than or equal to about 30 μm and a particle size distribution within +30% of the average particle diameter may be obtained. For example, the average particle diameter of the liquid metal microparticles may be greater than or equal to about 10 μm and less than or equal to about 30 μm, and the microparticles may have a narrow particle size distribution within +30% of each average particle diameter. That is, liquid metal microparticles having a very uniform particle size and being substantially spherical can be obtained by the method of preparing liquid metal microparticles according to an embodiment. Accordingly, another embodiment provides liquid metal microparticles having an average particle diameter of less than or equal to about 30 μm and a particle size distribution within +30% of the average particle diameter. The liquid metal microparticles are substantially spherical in shape.

The liquid metal microparticles prepared as described above may include a surfactant on their surface. Accordingly, the liquid metal microparticles may not be aggregated and exist stably within a dispersion solvent. If storage for a longer period of time is required, the microparticles may be frozen and stored.

The liquid metal microparticles according to an embodiment are uniformly spherical particles having an average particle diameter of less than or equal to about 30 μm and a low particle size distribution within +30% of the average particle diameter, and thus can be advantageously applied (e.g., used) in various fields. For example, the liquid metal microparticles may be applied as a conductive material for inkjet printing or electronic circuits of stretchable electronics. The liquid metal microparticles may also be applied as a heat dissipation material for thermal interface materials or heat dissipation fillers in electronic devices. The liquid metal microparticles may also be applied as a chemical reactant for catalysts, energy storage materials, or chemical sensors. The liquid metal microparticles may also be applied as a photothermal effect material for metal bonding reinforcement materials or medical biomaterials. However, the use of the liquid metal microparticles are not limited to the examples. Accordingly, another embodiment provides an electronic device including the liquid metal microparticles according to an embodiment.

When applying the liquid metal microparticles according to an embodiment in various fields, a composition in which the liquid metal microparticles are mixed with a polymer may be directly applied to a desired field, or a composite form in which a mixture of the microparticles and a polymer is cured may be applied in various fields. Accordingly, another embodiment provides a composite including liquid metal microparticles according to an embodiment dispersed within a polymer matrix.

The composite may be obtained by preparing spherical liquid metal microparticles having an average particle diameter of less than or equal to about 30 μm and a particle size distribution within +30% of the average particle diameter using the method of preparing liquid metal microparticles according to an embodiment, and combining, e.g., mixing, the prepared liquid metal microparticles with a polymer. Accordingly, another embodiment provides a method of preparing a composite including the liquid metal microparticles and a polymer. The polymer matrix used in the method of preparing the composite may be any polymer that is suitable for application to the desired purpose, including other liquid metal microparticles or general metal or ceramic fillers existing in each field, and is not limited to a specific type. In addition, the method of dispersing liquid metal microparticles in the polymer matrix is not particularly limited, and a composite may be easily prepared by mixing and stirring the polymer and liquid metal microparticles together.

The composite prepared as described above may be applied to various electronic devices, and thus, another embodiment provides an electronic device including a composite including liquid metal microparticles according to an embodiment dispersed in a polymer matrix.

Hereinafter, the embodiments are illustrated in more detail with reference to examples. However, these examples are exemplary, and the scope of claims is not limited thereto.

### Examples

### Example and Comparative Example: Preparation of Liquid Metal Microparticles

### (1) Preparation of Dispersion Solvent Including Surfactant

After preparing distilled water as a solvent for dispersing liquid metal microparticles, a surfactant for preventing aggregation of the liquid metal microparticles after being dispersed in the distilled water is added thereto. Herein, the surfactant is sodium dodecyl sulfate (SDS), an anionic surfactant, which is added to the distilled water to prepare a dispersion solvent. The amount of the surfactant is as described in Table 1, which is based on a total weight of the distilled water and the surfactant. In addition, as Comparative Example 1, the result of not including the surfactant is also shown in Table 1.

### (2) Preparation of Liquid Metal and Maintenance of Process Temperature

As liquid metal for preparing microparticles, an alloy containing 75.5% of gallium (Ga) and 24.5% of indium (In) was prepared, and each process was performed at 50° C., which was higher than 15.5° C. of a melting point of the alloy, or at 5° C., which was lower than the melting point of the alloy, and the results are shown in Table 1. Herein, both the temperature of the liquid metal before being ejected from a syringe and the temperature of the dispersion solvent were maintained at the process temperature, that is, 50° C. or 5° C.

### (3) Injection of Liquid Metal into Dispersion Solvent Using Syringe

The prepared Ga—In alloy, liquid metal, was added to a syringe including a nozzle and a piston, and then, ejected from the nozzle of the syringe into the dispersion solvent by moving the piston at a constant rate of 0.1 ml/min or 0.5 ml/min. The nozzle of the syringe was adjusted to have each inner diameter of 5 μm, 10 μm, 60 μm, and 110 μm, and the results are shown in Table 1.

The liquid metal was ejected from the nozzle, and simultaneously, dispersed as microparticles in the dispersion solvent due to high surface energy between the dispersion solvent and the liquid metal. The liquid metal was ejected as spherical microparticles into the solvent due to high surface tension, and the surfactant included in the solvent instantaneously reacted on the surface of the liquid metal microparticles to stably maintain the formed spherical particle structure.

TABLE 1

| | Nozzle | | Surfactant | | | Average diameter | |
|---|---|---|---|---|---|---|---|
| | inner | | concen- | Process | Injection | (±standard | *Uniformity |
| | diameter | | tration | temperature | rate | deviation) | (%) |
| Example 1 | 10 | μm | 5 wt % | 50° C. | 0.5 ml/min | 19.9 | 22.1% |
| | | | | | | (±4.4) μm | |
| Example 2 | 5 | μm | 5 wt % | 50° C. | 0.5 ml/min | 18.7 | 17.6% |
| | | | | | | (±3.3) μm | |
| Comparative | 10 | μm | 0 wt % | 50° C. | 0.5 ml/min | amorphous structure | |
| Example 1 | | | | | | | |
| Comparative | 10 | μm | 1 wt % | 50° C. | 0.5 ml/min | amorphous structure | |
| Example 2 | | | | | | | |
| Comparative | 10 | μm | 5 wt % | 5° C. | 0.5 ml/min | amorphous structure | |
| Example 3 | | | | | | | |
| Comparative | 10 | μm | 5 wt % | 50° C. | 0.1 ml/min | 94.1 | 17.8% |
| Example 4 | | | | | | (±16.7) μm | |
| Comparative | 60 | μm | 5 wt % | 50° C. | 0.5 ml/min | 122.1 | 11.21% |
| Example 5 | | | | | | (±13.7) μm | |
| Comparative | 110 | μm | 5 wt % | 50° C. | 0.5 ml/min | 297.4 | 20.5% |

| | |
|---|---|
| Example 6 | (±61.2) μm |

*uniformity (%) = (standard deviation/average diameter) × 100

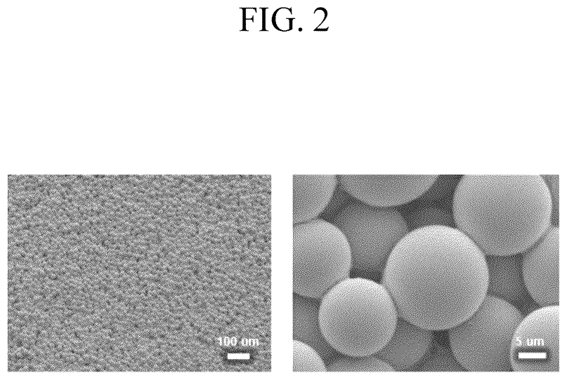

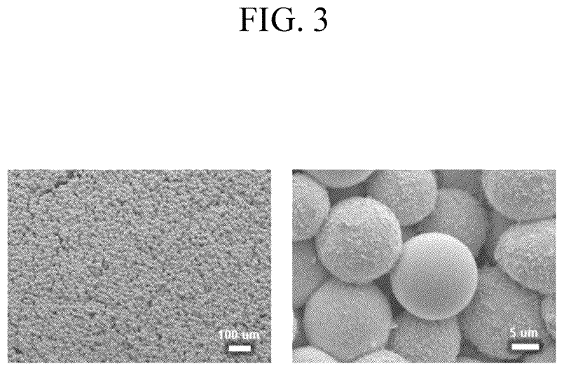

As shown in Table 1, according to an embodiment, when the surfactant was used at a concentration of 5 wt %, which was greater than or equal to 3 wt %, the process temperature was set at 50° C., which was higher the melting point of the liquid metal, and the injection rate was set at greater than or equal to 0.5 mL/min, highly uniform spherical liquid metal microparticles having an average particle diameter of 19.9 (+4.4) μm and 18.7 (+3.3) μm, which satisfied less than or equal to about 30 μm, and exhibiting a standard deviation within a range of+30% of each average particle diameter were obtained. FIG. 2 and FIG. 3 are scanning electron microscope (SEM) images of the microparticles respectively. Example 2, in which the inner diameter of the nozzle was adjusted to be smaller, provided the microparticles having a smaller average diameter than Example 1.

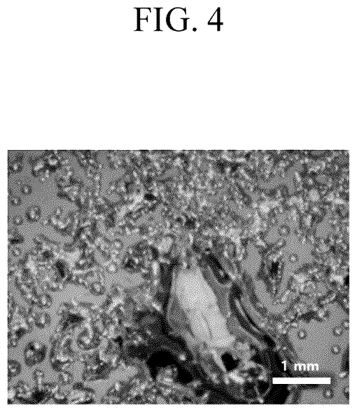

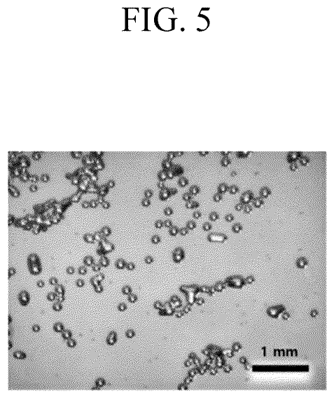

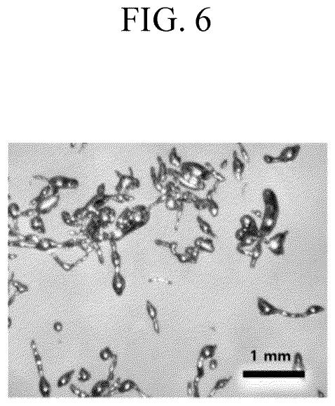

On the other hand, Comparative Examples 1 to 3, which included no surfactant or the surfactant at a concentration of less than 3 wt %, exhibited no microparticulate structure in the dispersion solvent but an amorphous structure (please see FIGS. 4 to 6).

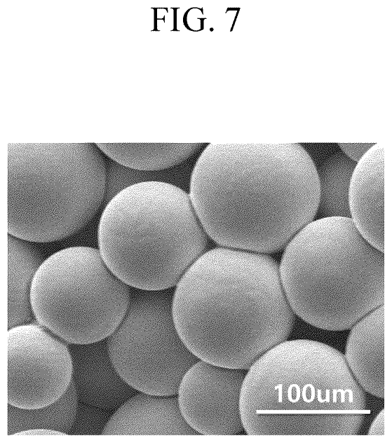

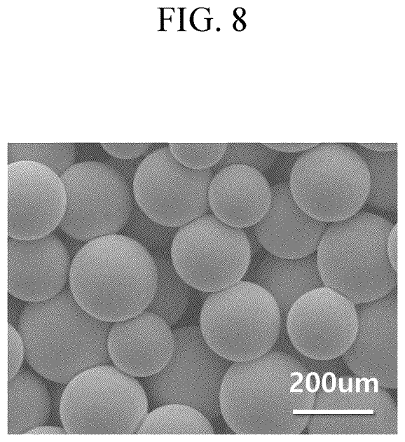

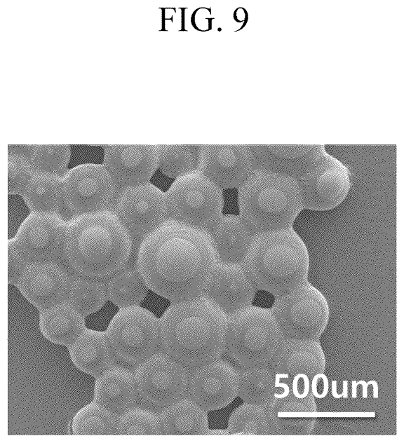

Comparative Example 4, in which the injection rate was changed to 0.1 mL/min, which was lower than 0.5 mL/min under the same remaining conditions as in Example 1, provided microparticles with an average diameter of 94.1 μm, which was larger than 30 μm (refer to FIG. 7), and Comparative Examples 5 and 6, in which the inner diameter of the nozzle was changed respectively to 60 μm and 110 μm under the same remaining conditions as in Example 1, provided very large particles with an average diameter of 122.1 μm and 297.4 μm (refer to FIGS. 8 and 9), which were not microparticles having an average diameter of less than or equal to about 30 μm.

In conclusion, spherical liquid metal microparticles having an average diameter of less than or equal to about 30 μm and a particle size distribution within +30% of the average diameter are prepared by dispersing liquid metal into a dispersion solvent by using a syringe having a nozzle of the syringe set to have a diameter of less than or equal to about 30 μm, an injection rate of the liquid metal with the syringe set at greater than or equal to 0.5 mL/min, and a surfactant in the dispersion solvent at a concentration of greater than or equal to 3 wt %,.

### Preparation Example 1: Preparation of Liquid Metal Thermal Interface Material

The liquid metal microparticles according to Example 1 were used to manufacture a thermal interface material pad. A thermal interface material was prepared by dispersing the spherical Ga—In alloy microparticles with an average particle diameter of 19.9 μm according to Example 1 at a content of 80 wt % in polyvinyl alcohol (PVA), and drying the same at 50° C. for 2 hours.

The manufactured thermal interface material pad was measured with respect to thermal conductivity by using a thermal conductivity analyzer (C-THERM, TRIDENT), and the result was about 9 watts per meter-kelvin (W/mK). This result was much higher than that of a thermal interface material pad currently in use, which is about 5 W/mK. Accordingly, the liquid metal microparticles according to an embodiment turned out to be advantageously used as a heat dissipation filler of a thermal interface material.

While this disclosure has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

What is claimed is:

1. A method of preparing liquid metal microparticles, comprising
injecting a liquid metal into a solvent using a syringe,
wherein the syringe comprises a piston and a nozzle, a diameter of the nozzle is less than or equal to about 30 micrometers, and an injection rate of the liquid metal with the syringe is greater than or equal to about 0.5 milliliters per minute,
the solvent comprises a surfactant in an amount of greater than or equal to about 3 weight percent based on a total weight of the surfactant and the solvent, and
the liquid metal and the solvent are each maintained at a temperature greater than or equal to a melting point of the liquid metal.

2. The method of claim 1, wherein the liquid metal comprises gallium, indium, tin, bismuth, copper, mercury, lead, gold, silver, or an alloy thereof.

3. The method of claim 1, wherein the solvent comprises ethanol, water, isopropyl alcohol, acetone, or a mixture thereof.

4. The method of claim 1, wherein the surfactant comprises a cationic surfactant, an anionic surfactant, a nonionic surfactant, or a combination thereof.

5. The method of claim 1, wherein the surfactant comprises an anionic surfactant and the anionic surfactant comprises sodium dodecyl sulfate.

6. The method of claim 1, wherein the temperature is greater than or equal to the melting point of the liquid metal is greater than or equal to about 40° C. and less than or equal to about 60° C.

7. The method of claim 1, wherein the liquid metal comprises gallium and indium, and the temperature greater than or equal to the melting point of the liquid metal is about 45° C. to about 55° C.

8. The method of claim 1, wherein an average particle diameter of the liquid metal microparticles is less than or equal to about 30 micrometers, and the liquid metal microparticles have a particle size distribution within +30% of the average particle diameter.

9. The method of claim 1, wherein the diameter of the nozzle of the syringe is greater than or equal to about 1 micrometers and less than or equal to about 20 micrometers.

10. The method of claim 1, wherein the diameter of the nozzle of the syringe is greater than or equal to about 5 micrometers and less than or equal to about 10 micrometers.

11. The method of claim 10, wherein an average particle diameter of the liquid metal microparticles is greater than or equal to about 10 micrometers and less than or equal to about 30 micrometers, and the liquid metal microparticles have a particle size distribution within +30% of the average particle diameter.

12. The method of claim 1, wherein the method prepares liquid metal microparticles at a rate of greater than or equal to about 150 grams per hour.

13. Liquid metal microparticles having an average particle diameter of less than or equal to about 30 micrometers and a particle size distribution within +30% of the average particle diameter.

14. The liquid metal microparticles of claim 13, wherein the liquid metal microparticles comprise gallium, indium, tin, bismuth, copper, mercury, lead, gold, silver, or an alloy thereof.

15. The liquid metal microparticles of claim 13, wherein the liquid metal microparticles comprise a surfactant on their surface.

16. A method of preparing a composite, comprising
producing the liquid metal microparticles prepared by the method of claim 1 to provide a prepared liquid metal microparticles, and
mixing the prepared liquid metal microparticles with a polymer.

17. The method of claim 16, wherein the composite is included in an inkjet composition, electronic circuits, thermal interface materials, a heat dissipation sheet, an energy storage device, a chemical sensor, a conductive metal bonding material, or a medical biomaterial.

18. A composite comprising liquid metal microparticles dispersed within a polymer matrix, wherein the liquid metal microparticles have an average particle diameter of less than or equal to about 30 micrometers and a particle size distribution within +30% of the average particle diameter, and are spherical.

19. The composite of claim 18, wherein the liquid metal microparticles comprise gallium, indium, tin, bismuth, copper, mercury, lead, gold, silver, or an alloy thereof.

20. An electronic device comprising the liquid metal microparticles according to claim 13.
